(19) United States
(12) Patent Application Publication
(10) Pub. No.: US 2026/0247246 A1
(43) Pub. Date: Aug. 20, 2026

(54) WIRELESS NETWORK FOR INTERNET FAILOVER AND POWER-OUTAGE RESILIENCE

(71) Applicant: MaxLinear, Inc., Carlsbad, CA (US)

(72) Inventors: Saju Palayur, Poway, CA (US); William Lupetini Ross-Ashikyan, San Diego, CA (US)

(73) Assignee: MaxLinear, Inc., Carlsbad, CA (US)

(21) Appl. No.: 19/542,574

(22) Filed: Feb. 17, 2026

Related U.S. Application Data
(60) Provisional application No. 63/759,128, filed on Feb. 15, 2025.

(51) Int. Cl. H04W 36/30; H04W 12/02; H04W 16/26; H04W 76/14

(52) U.S. Cl. CPC H04W 36/305; H04W 12/02; H04W 16/26; H04W 76/14

(57) ABSTRACT

An access point (AP) may include a processing device. The processing device may detect, at the AP, a failure of a first network link. The processing device may determine, at the AP, a path to a second network link. The processing device may activate, at the AP, a backup long-range wireless communication device when the failure of the first network link is detected, in which the backup long-range wireless communication device facilitates a connection to the second network link. The processing device may connect, at the AP, to the second network link using the backup long-range wireless communication device.

### RELATED APPLICATION

This application claims the benefit of U.S. Provisional Application No. 63/759,128, filed February 15, 2025, the disclosure of which is incorporated herein by reference in its entirety for all purposes.

The examples discussed in the present disclosure are related to wireless networks for internet failover and power-outage resilience.

### BACKGROUND

Unless otherwise indicated herein, the materials described herein are not prior art to the claims in the present application and are not admitted to be prior art by inclusion in this section.

An access point (AP), is a networking hardware device that allows other Wi-Fi® devices to connect to a wired network. As a standalone device, the AP may have a wired connection to a router, but, in a wireless router, it can also be an integral component of the router itself. There are many wireless data standards that have been introduced for wireless access point and wireless router technology such as 802.11a, 802.11b, 801.11g, 802.11n (Wi-Fi® 4), 802.11ac (Wi-Fi® 5), 802.11ax (Wi-Fi® 6), and so forth.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, an access point (AP) may include a processing device. The processing device may detect, at the AP, a failure of a first network link. The processing device may determine, at the AP, a path to a second network link. The processing device may activate, at the AP, a backup long-range wireless communication device when the failure of the first network link is detected, in which the backup long-range wireless communication device facilitates a connection to the second network link. The processing device may connect, at the AP, to the second network link using the backup long-range wireless communication device.

In some examples, a method for maintaining internet connectivity may include detecting, at an AP, a failure of a first network link. The method may include determining, at the AP, a path to a second network link. The method may include activating, at the AP, a backup long-range wireless communication device when the failure of the first network link is detected, in which the backup long-range wireless communication device facilitates a connection to the second network link. The method may include connecting, at the AP, to the second network link using the backup long-range wireless communication device.

In some examples, a device may include a power source and a coaxial cable. The coaxial cable may send, from the device to the one or more of an internet gateway or an access point (AP), internet connectivity. The coaxial cable may send, from the device to one or more of the internet gateway or the AP, power from the power source when a power outage occurs. The one or more of the internet gateway or the AP may not include a battery backup power source.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example block diagram of a wireless network for internet failover and power outage resilience.

FIG. 2 illustrates an example power backup and centralized power distribution.

FIG. 3 illustrates a process flow of a wireless network for internet failover and power outage resilience.

FIG. 4 illustrates a process flow of power backup and centralized power distribution.

FIG. 5 illustrates a block diagram of an example system operable to perform any one or more of the methods discussed herein.

FIG. 6 illustrates a diagrammatic representation of a machine in the example form of a computing device within which a set of instructions, for causing the machine to perform any one or more of the methods discussed herein, may be executed.

### DESCRIPTION

Access points (APs) may facilitate internet connectivity to stations (STAs). When a power outage occurs, the APs may encounter a break in internet connectivity. In addition, power may be provided to the APs but there may be a break in internet connectivity for other reasons. Therefore, methods for internet failover and power outage resilience may be useful.

A method and system for providing a resilient, long-range wireless network that may maintain internet connectivity in the event of fiber or cable modem failure, as well as during power outages, is provided. The system may leverage a peer-to-peer (P2P) wireless network using long-range communication protocols to extend coverage with or without centralized infrastructure.

This system may utilize Wi-Fi® APs with integrated long-range wireless connectivity to form a dynamic, self-healing network. The AP may be equipped with a battery backup and an alternative wireless communication module (e.g., 802.11ah HaLow, 5 GHz Wi-Fi®, TV White Space, LoRaWAN, Private long term evolution (LTE)/fifth generation (5G)) to maintain network connectivity when the primary internet service provider (ISP) link fails. The alternative wireless communication module may be low- throughput when compared to the primary ISP link. The alternative wireless communication module may serve multiple clients. The network may dynamically find the best path to an active internet connection, enabling seamless failover and extended connectivity.

Some features of the system may include: (1) support for peer-to-peer networks and centralized towers – providing flexibility in deployment, (2) seamless failover & self-healing network to facilitate uninterrupted connectivity, (3) battery-backed APs for power outages and extended network operation, and/or (4) multi-hop routing to extend range across a neighborhood.

In addition or alternatively, a mesh network backbone may be provided. The mesh network backbone may provide a robust, high-speed interconnection for multiple APs in a mesh setup, enhancing performance and reliability. In a home mesh Wi-Fi® scenario with three or four access points (APs), the long-range wireless link may also serve as a high-speed backbone to interconnect the APs. This backbone may enhance the stability and performance of the mesh network, especially in large homes or areas with challenging wireless environments where traditional mesh links may suffer from interference or weak signal strength. The mesh network backbone may be applied e.g., in large residential properties using stable, high-performance mesh networking.

In addition or alternatively, a path to the second network link may include one or more intermediate access points that extend communication range; or communications between the AP and the second network link may be encrypted for privacy.

In addition or alternatively, a centralized power distribution system may be used for internet gateways and access points using coaxial cable while simultaneously providing internet connectivity. The system ensures network resilience during power outages. Instead of using individual battery backups for the gateway or AP, this system may supply centralized power over coaxial cables, which may also serve as internet distribution lines. The power can be sourced from e.g., a centralized backup power unit with uninterruptable power supply (UPS) or solar integration, a distributed battery network where power is pooled from multiple locations, and/or smart energy management to optimize battery use and prevent failures. Alternatively or in addition, the power source may be configured to receive power from one or more access points having backup power sources and redistribute the power to other access points via one or more communication lines.

Some features include a reliable power supply for gateways & APs during outages which may eliminate the use of individual battery packs, reducing maintenance and supporting seamless connectivity & power delivery over a single medium.

Examples of the present disclosure will be explained with reference to the accompanying drawings.

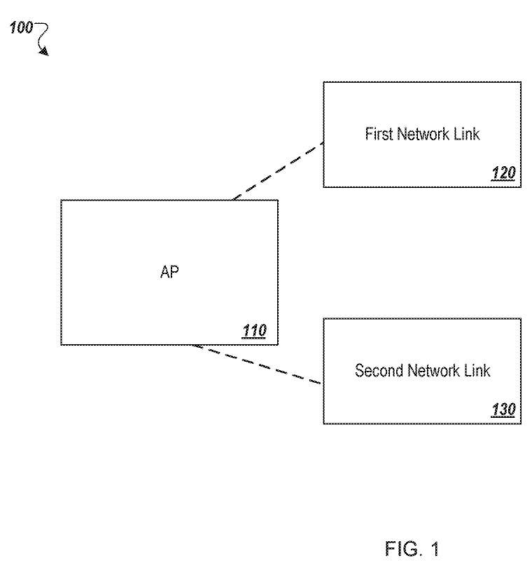

In some examples, FIG. 1 illustrates a block diagram 100 showing an AP 110 which may include a processing device. The processing device may detect, at the AP 110, a failure of a first network link 120. The processing device may determine, at the AP 110, a path to a second network link 130. The processing device activate, at the AP 110, a backup long-range wireless communication device when the failure of the first network link 120 is detected in which the backup long-range wireless communication device may facilitate a connection to the second network link 130. The processing device may connect, at the AP 110, to the second network link 130 using the backup long-range wireless communication device.

The processing device may determine the path to the second network link 130 using multi-hop routing. The second network link 130 may be connected to a peer-to-peer (P2P) network. The second network link 130 may be connected to a centralized tower to facilitate extended coverage. The second network link may facilitate a mesh network backbone.

The access point 110 may include a backup power source. The processing device may switch to the backup power source when a power outage is detected. The power from the backup power source may be provided using coaxial cables.

The backup long-range wireless communication device may use any suitable communication medium. For example, the backup long-range wireless communication device may use one or more of an Institute of Electrical and Electronics Engineers (IEEE) 802.11ah protocol, a 5 gigahertz (GHz) 802.11 protocol, television white space frequency bands, long range wide area network (LoRaWAN), Third Generation Partnership Project (3GPP) long-term evolution (LTE), or 3GPP 5G.

Modifications, additions, or omissions may be made to the components of FIG. 1 without departing from the scope of the present disclosure.

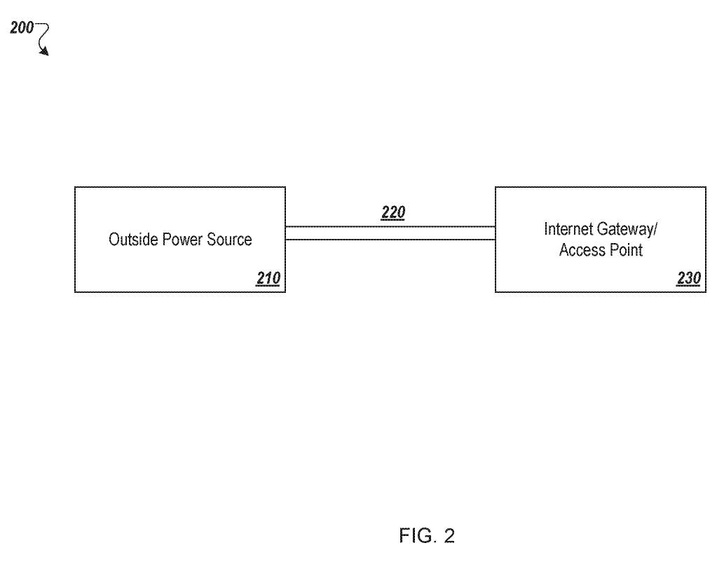

As illustrated in the block diagram 200 in FIG. 2, a device may include an outside power source 210 and a coaxial cable 220. The outside power source 210 may not be local to the one or more of an internet gateway or an access point 230. The coaxial cable 220 may send, from the device to the one or more of an internet gateway or an AP 230, internet connectivity. The coaxial cable 220 may send, from the device to one or more of the internet gateway or the AP 230, power from the power source 210 when a power outage occurs. The power source 210 may be one or more of UPS or solar power. The power source 210 may be a distributed battery network in which the power is pooled from multiple locations. The power source 210 may be facilitated using smart energy management to facilitate power reduction when compared to a baseline amount of power usage when smart energy management is not used. The power source 210 may be a centralized power supply. The coaxial cable 220 may switch to the power source 210 when a power outage occurs to facilitate internet connectivity without a network outage.

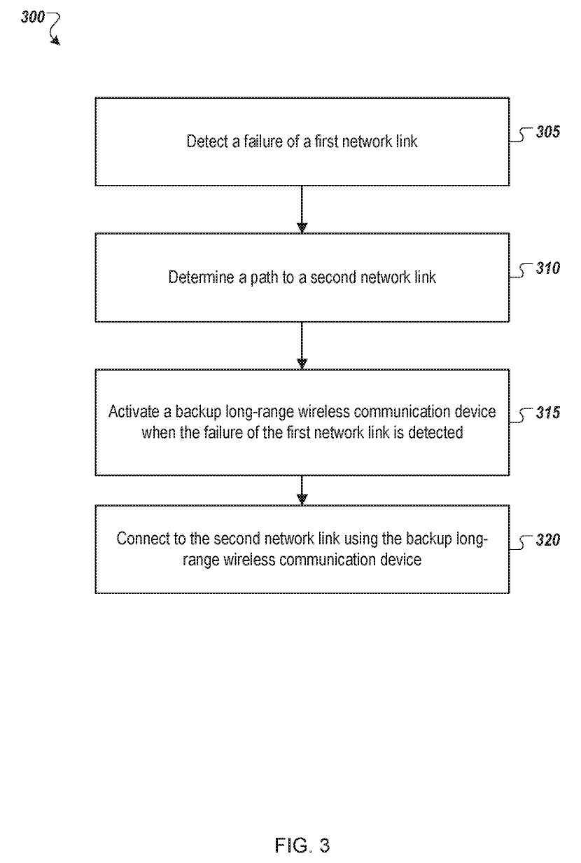

FIG. 3 illustrates a process flow of an example method 300 of long-range wireless network for internet failover and power outage resilience, in accordance with at least one example described in the present disclosure. The method 300 may be arranged in accordance with at least one example described in the present disclosure.

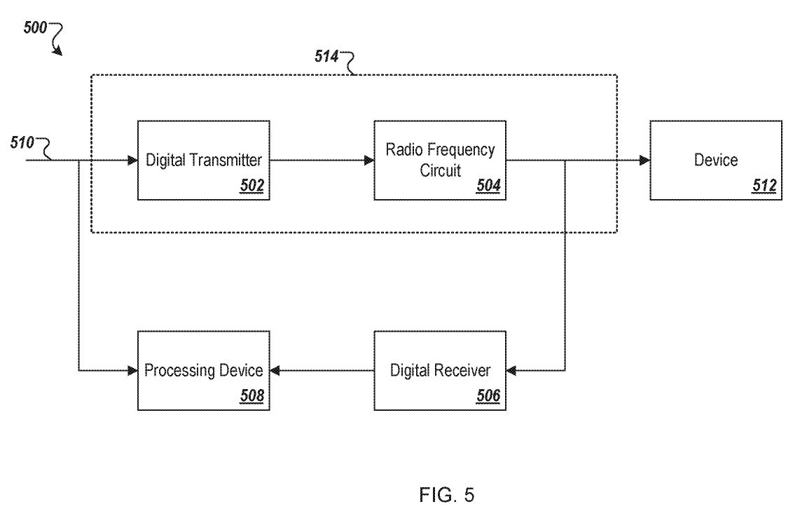

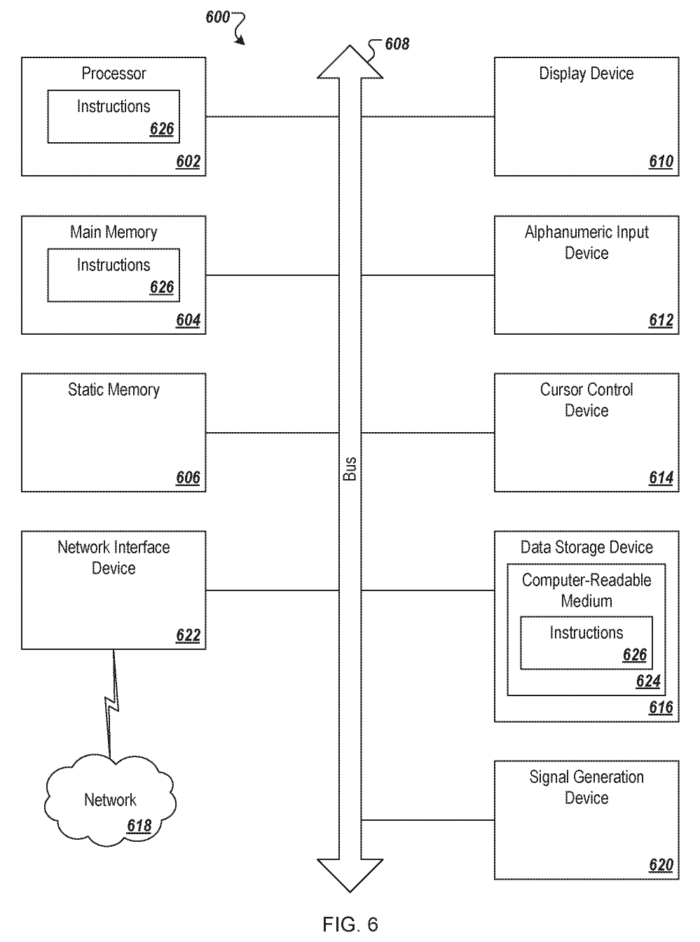

The method 300 may be performed by processing logic that may include hardware (circuitry, dedicated logic, etc.), software (such as is run on a computer system or a dedicated machine), or a combination of both, which processing logic may be included in the processing device 602 of FIG. 6, the communication system 500 of FIG. 5, or another device, combination of devices, or systems.

The method 300 may begin at block 305 where the processing logic may detect, at an AP, a failure of a first network link.

At block 310, the processing logic may determine, at the AP, a path to a second network link.

At block 315, the processing logic may activate, at the AP, a backup long-range wireless communication device when the failure of the first network link is detected. The backup long-range wireless communication device may facilitate a connection to the second network link.

At block 320, the processing logic may connect, at the AP, to the second network link using the backup long-range wireless communication device.

The processing logic may determine, at the AP, the path to the second network link using multi-hop routing. The second network link may be connected to a peer-to-peer (P2P) network. The second network link may be connected to a centralized tower to facilitate extended coverage. The second network link may facilitate a mesh network backbone.

The backup long-range wireless communication device may use one or more of an Institute of Electrical and Electronics Engineers (IEEE) 802.11ah protocol, a 5 gigahertz (GHz) 802.11 protocol, television white space frequency bands, long range wide area network (LoRaWAN), Third Generation Partnership Project (3GPP) long-term evolution (LTE), or 3GPP 5G.

The processing logic may switch to a backup power source when a power outage is detected. The power from the backup power source may be provided using coaxial cables.

Modifications, additions, or omissions may be made to the method 300 without departing from the scope of the present disclosure. For example, in some examples, the method 300 may include any number of other components that may not be explicitly illustrated or described.

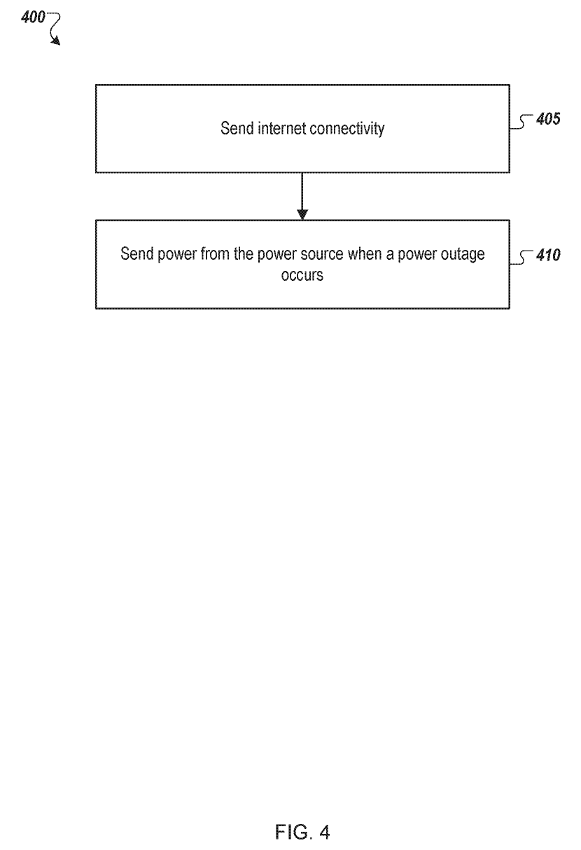

FIG. 4 illustrates a process flow of an example method 400 of power backup and centralized power distribution, in accordance with at least one example described in the present disclosure. The method 400 may be arranged in accordance with at least one example described in the present disclosure.

The method 400 may be performed by processing logic that may include hardware (circuitry, dedicated logic, etc.), software (such as is run on a computer system or a dedicated machine), or a combination of both, which processing logic may be included in the processing device 602 of FIG. 6, the communication system 500 of FIG. 5, or another device, combination of devices, or systems.

The method 400 may begin at block 405 where the processing logic may send, from the device to the one or more of an internet gateway or an access point (AP), internet connectivity.

At block 410, the processing logic may send, from the device to one or more of the internet gateway or the AP, power from the power source when a power outage occurs.

Modifications, additions, or omissions may be made to the method 400 without departing from the scope of the present disclosure. For example, in some examples, the method 400 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 5 illustrates a block diagram of an example communication system 500, in accordance with at least one example described in the present disclosure. The communication system 500 may include a digital transmitter 502, a radio frequency circuit 504, a device 512, a digital receiver 506, and a processing device 508. The digital transmitter 502 and the processing device 508 may receive a baseband signal via connection 510. A transceiver 514 may include the digital transmitter 502 and the radio frequency circuit 504.

In some examples, the communication system 500 may include a system of devices that may communicate with one another via a wired or wireline connection. For example, a wired connection in the communication system 500 may include one or more Ethernet cables, one or more fiber-optic cables, and/or other similar wired communication mediums. Alternatively, or additionally, the communication system 500 may include a system of devices that may communicate via one or more wireless connections. For example, the communication system 500 may include one or more devices that may transmit and/or receive radio waves, microwaves, ultrasonic waves, optical waves, electromagnetic induction, and/or similar wireless communications. Alternatively, or additionally, the communication system 500 may include combinations of wireless and/or wired connections. In these and other examples, the communication system 500 may include one or more devices that may obtain a baseband signal, perform one or more operations to the baseband signal to generate a modified baseband signal, and transmit the modified baseband signal, such as to one or more loads.

In some examples, the communication system 500 may include one or more communication channels that may communicatively couple systems and/or devices included in the communication system 500. For example, the transceiver 514 may be communicatively coupled to the device 512.

In some examples, the transceiver 514 may obtain a baseband signal. For example, as described herein, the transceiver 514 may generate a baseband signal and/or receive a baseband signal from another device. In some examples, the transceiver 514 may transmit the baseband signal. For example, upon obtaining the baseband signal, the transceiver 514 may transmit the baseband signal to a separate device, such as the device 512. Alternatively, or additionally, the transceiver 514 may modify, condition, and/or transform the baseband signal in advance of transmitting the baseband signal. For example, the transceiver 514 may include a quadrature up-converter and/or a digital to analog converter (DAC) that may modify the baseband signal. Alternatively, or additionally, the transceiver 514 may include a direct radio frequency (RF) sampling converter that may modify the baseband signal.

In some examples, the digital transmitter 502 may obtain a baseband signal via connection 510. In some examples, the digital transmitter 502 may up-convert the baseband signal. For example, the digital transmitter 502 may include a quadrature up-converter to apply to the baseband signal. In some examples, the digital transmitter 502 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 502.

In some examples, the transceiver 514 may include one or more subcomponents that may be used in preparing the baseband signal and/or transmitting the baseband signal. For example, the transceiver 514 may include an RF front end (e.g., in a wireless environment) which may include a power amplifier (PA), a digital transmitter (e.g., 502), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, or the like. In some examples, a radio (e.g., a radio frequency circuit 504) of the transceiver 514 may be synchronized with the resource controller via the S-plane device, which may contribute to high-accuracy timing with respect to a reference clock.

In some examples, the transceiver 514 may obtain the baseband signal for transmission. For example, the transceiver 514 may receive the baseband signal from a separate device, such as a signal generator. For example, the baseband signal may come from a transducer that may convert a variable into an electrical signal, such as an audio signal output of a microphone picking up a speaker's voice. Alternatively, or additionally, the transceiver 514 may generate a baseband signal for transmission. In these and other examples, the transceiver 514 may transmit the baseband signal to another device, such as the device 512.

In some examples, the device 512 may receive a transmission from the transceiver 514. For example, the transceiver 514 may transmit a baseband signal to the device 512.

In some examples, the radio frequency circuit 504 may transmit the digital signal received from the digital transmitter 502. In some examples, the radio frequency circuit 504 may transmit the digital signal to the device 512 and/or the digital receiver 506. In some examples, the digital receiver 506 may receive a digital signal from the RF circuit and/or send a digital signal to the processing device 508.

In some examples, the processing device 508 may be a standalone device or system, as illustrated. Alternatively, or additionally, the processing device 508 may be a component of another device and/or system. For example, in some examples, the processing device 508 may be included in the transceiver 514. In instances in which the processing device 508 is a standalone device or system, the processing device 508 may communicate with additional devices and/or systems remote from the processing device 508, such as the transceiver 514 and/or the device 512. For example, the processing device 508 may send and/or receive transmissions from the transceiver 514 and/or the device 512. In some examples, the processing device 508 may be combined with other elements of the communication system 500.

FIG. 6 illustrates a diagrammatic representation of a machine in the example form of a computing device 600 within which a set of instructions, for causing the machine to perform any one or more of the methods discussed herein, may be executed. The computing device 600 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 600 includes a processing device (e.g., a processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)) and a data storage device 616, which communicate with each other via a bus 608.

Processing device 602 represents one or more general-purpose processing devices such as a microprocessor, central processing unit, or the like. More particularly, the processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also include one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computing device 600 may further include a network interface device 622 which may communicate with a network 618. The computing device 600 also may include a display device 610 (e.g., a liquid crystal display (LCD) or a cathode ray tube (CRT)), an alphanumeric input device 612 (e.g., a keyboard), a cursor control device 614 (e.g., a mouse) and a signal generation device 620 (e.g., a speaker). In at least one example, the display device 610, the alphanumeric input device 612, and the cursor control device 614 may be combined into a single component or device (e.g., an LCD touch screen).

The data storage device 616 may include a computer-readable storage medium 624 on which is stored one or more sets of instructions 626 embodying any one or more of the methods or functions described herein. The instructions 626 may also reside, completely or at least partially, within the main memory 604 and/or within the processing device 602 during execution thereof by the computing device 600, the main memory 604 and the processing device 602 also constituting computer-readable media. The instructions may further be transmitted or received over a network 618 via the network interface device 622.

While the computer-readable storage medium 624 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media, and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. An access point (AP), comprising:
a processing device operable to:
detect, at the AP, a failure of a first network link;
determine, at the AP, a path to a second network link;
activate, at the AP, a backup long-range wireless communication device when the failure of the first network link is detected, wherein the backup long-range wireless communication device facilitates a connection to the second network link; and
connect, at the AP, to the second network link using the backup long-range wireless communication device.

2. The AP of claim 1, further comprising:
a backup power source,
wherein the processing device is further operable to switch to the backup power source when a power outage is detected.

3. The AP of claim 2, wherein power from the backup power source is provided using coaxial cables.

4. The AP of claim 1, wherein the second network link is connected to a peer-to-peer (P2P) network.

5. The AP of claim 1, wherein the second network link is connected to a centralized tower to facilitate extended coverage.

6. The AP of claim 1, wherein the backup long-range wireless communication device uses one or more of an Institute of Electrical and Electronics Engineers (IEEE) 802.11ah protocol, a 5 gigahertz (GHz) 802.11 protocol, television white space frequency bands, long range wide area network (LoRaWAN), Third Generation Partnership Project (3GPP) long-term evolution (LTE), or 3GPP 5G.

7. The AP of claim 1, wherein:
the second network link facilitates a mesh network backbone; or
a path to the second network link comprises one or more intermediate access points that extend communication range; or
communications between the AP and the second network link are encrypted for privacy.

8. A method for maintaining internet connectivity, comprising:
detecting, at an AP, a failure of a first network link;
determining, at the AP, a path to a second network link;
activating, at the AP, a backup long-range wireless communication device when the failure of the first network link is detected, wherein the backup long-range wireless communication device facilitates a connection to the second network link; and
connecting, at the AP, to the second network link using the backup long-range wireless communication device.

9. The method of claim 8, wherein the second network link is connected to a peer-to-peer (P2P) network.

10. The method of claim 8, wherein the second network link is connected to a centralized tower to facilitate extended coverage.

11. The method of claim 8, wherein the backup long-range wireless communication device uses one or more of an Institute of Electrical and Electronics Engineers (IEEE) 802.11ah protocol, a 5 gigahertz (GHz) 802.11 protocol, television white space frequency bands, long range wide area network (LoRaWAN), Third Generation Partnership Project (3GPP) long-term evolution (LTE), or 3GPP 5G.

12. The method of claim 8, further comprising:
switching to a backup power source when a power outage is detected.

13. The method of claim 12, wherein power from the backup power source is provided using coaxial cables.

14. The method of claim 8, wherein the second network link facilitates a mesh network backbone.

15. A device, comprising:
a power source; and
a coaxial cable operable to:
send, from the device to the one or more of an internet gateway or an access point (AP), internet connectivity; and
send, from the device to one or more of the internet gateway or the AP, power from the power source when a power outage occurs,
wherein the one or more of the internet gateway or the AP does not include a battery backup power source.

16. The device of claim 15, wherein the power source comprises one or more of uninterruptable power supply (UPS) or solar power.

17. The device of claim 15, wherein the power source is a distributed battery network wherein the power is pooled from a plurality of locations.

18. The device of claim 15, wherein the power source is facilitated using smart energy management to facilitate power reduction when compared to a baseline amount of power usage.

19. The device of claim 15, wherein the power source is a centralized power supply.

20. The device of claim 15, wherein the coaxial cable is operable to switch to the power source when a power outage occurs to facilitate internet connectivity without a network outage.
